(19) United States
(12) Patent Application Publication
(10) Pub. No.: US 2026/0042888 A1
(43) Pub. Date: Feb. 12, 2026

(54) Lignin as Superhydrophobic Agent and Dispersant for Superhydrophobic and Flame-Retardant Polyurethane Composite Coating

(71) Applicant: Lakehead University, Thunder Bay (CA)

(72) Inventors: Pedram Fatehi, Thunder Bay (CA); Banchamlak Kassaun, Thunder Bay (CA)

(21) Appl. No.: 19/296,099

(22) Filed: Aug. 11, 2025

Related U.S. Application Data
(60) Provisional application No. 63/682,090, filed on Aug. 12, 2024.

(51) Int. Cl. C08J 3/07; C08K 3/22; C08K 5/41; C08K 5/5415; C09D 5/02; C09D 5/18; C09D 175/04; C09D 197/02

(52) U.S. Cl. CPC C08J 3/07; C08K 3/22; C08K 5/41; C08K 5/5415; C09D 5/022; C09D 5/18; C09D 175/04; C09D 197/02; C08J 2397/02; C08J 2475/04

(57) ABSTRACT

A novel water-based superhydrophobic, flame-retardant, and recyclable PU film was prepared using lignin and PU water emulsion. In two different pathways. KL was utilized to generate a superhydrophobic and flame-retardant material (WL) and a dispersant (SL) for PU formulation.

### CROSS REFERENCES TO PRIORITY APPLICATIONS

The instant application claims the benefit of U.S. Provisional Patent Application 63/682,090, filed Aug. 12, 2024, entitled “LIGNIN AS SUPERHYDROPHOBIC AGENT AND DISPERSANT FOR SUPERHYDROPHOBIC AND FLAME-RETARDANT POLYURETHANE COMPOSITE COATING”, the entire contents of which are incorporated herein by reference for all purposes.

### BACKGROUND OF THE INVENTION

Polyurethane (PU) is a polymer made of isocyanate, a hard segment, and polyol, a soft segment, to form a repeating urethane group [1]. Due to its high substrate adhesion and mechanical properties, PU is used in many applications [2], e.g., adhesives, coatings, adsorbents, and elastomers [3]. Nevertheless, PU exhibits poor waterproofing and thermal stability performance [4]. In PU formulations, polar groups and hydrophilic components affect water repellency, yielding poor hydrophobicity [2,5]. In addition, PU's urethane linkages are susceptible to oxidation and hydrolysis, making it thermally unstable [6]. Due to its significant flammability and absence of hydrophobic properties, PU application is limited for wood coatings [7]. Moreover, using non-renewable petroleum-based ingredients in PU fabrication is known to be environmentally unfriendly [8]. The hydrophobic properties of PU materials can be improved by decreasing surface energy and generating rough surfaces utilizing silicide and fluoride [9]. Despite its acceptable flame retardancy, the use of fluoride in PU may have negative environmental implications and is thus not acceptable [10]. Currently, the PU industry seeks ways to reduce its environmental impact while improving the hydrophobicity and thermal properties of PU products [8].

Lignin is a natural polymer and can be utilized in PU composites to enhance their properties and reduce their environmental impact [11]. Lignin is highly favorable for PU composites due to its abundance, biodegradability, functionality, and multi-functionality. Adding lignin to PU composites improves PU material's resistance to heat and flammability by promoting the formation of char layers [11]. In addition, due to the strong interaction between lignin and the PU matrix, lignin could improve the tensile strength, modulus, and elongation at break [12]. However, lignin-based PU composites still face challenges. The reasons include poor compatibility of lignin and PU (due to poor dispersion) and the composite's reduced hydrophobicity and mechanical properties at a higher lignin content (e.g., 5 wt. %) [13]. Some common strategies to improve the interfacial adhesion and dispersion of lignin in the PU matrix are lignin nanoparticle production [14], chemical modification of lignin [15], and the addition of compatibilizers in the PU-lignin matrix [16]. For example, wheat straw-based lignin nanoparticles were utilized as a nanofiller for PU film production [14a], and its 5 wt. % improved the water contact angle of the PU film by 49° and increased tensile strength by 36%. However, the tensile strength dropped at a higher concentration due to lignin aggregation creating structural defect spots in the PU matrix. In another study, Wang et al. used biorefinery lignin after fractionation followed by alkylation in anhydrous 1˜4 dioxane solvent, and its 30 wt. % incorporation improved the corrosion resistance of coated aluminum surfaces. In contrast, the impact of lignin derivatives on the mechanical properties and hydrophobicity of PU was not elaborated [15a]. Also, two-step modification may be economically unviable on a larger scale. In another investigation, adding 0.5 wt. % of 3-aminopropyltriethoxy silane (APTES) functionalized lignin in PU films led to a 9% boost in tensile strength and improved thermal stability [15c]. At a higher dosage, the strength and thermal properties of the PU film dropped due to poor dispersion and agglomeration. Hence, it is necessary to determine a pathway to incorporate kraft lignin in the production of PU film at a higher concentration while improving the mechanical, thermal, and hydrophobic characteristics of PU films.

### SUMMARY OF THE INVENTION

According to an aspect of the invention, there is provided a method of synthesizing a polyurethane copolymer comprising:
a) mixing a first lignin and a suitable silsquioxane molecule, thereby forming a copolymerized lignin;
b) mixing a second lignin and a base, thereby forming a mixture;
adding a sulfoethylation reagent to the mixture and refluxing the mixture, thereby forming a sulfoethylated lignin; and
recovering the sufloethylated lignin
c) mixing the copolymerized lignin, the sufloethylated lignin and a polyurethane, thereby forming the polyurethane copolymer.

According to another aspect of the invention, there is provided a film prepared from a polyurethane copolymer prepared as described above.

According to another aspect of the invention, there is provided a method of improved hydrophobicity of an article comprising coating the article with a polyurethane copolymer prepared according to the method described above, said article having higher hydrophobicity than an identical article except for the polyurethane copolymer coating.

According to another aspect of the invention, there is provided a method of improved fire retardant properties of an article comprising coating the article with a polyurethane copolymer prepared according to the method as described above, said article having higher fire retardant properties than an identical article except for the polyurethane copolymer coating.

### BRIEF DESCRIPTION OF THE DRAWINGS

FIG. 1. 1H-NMR (a), HSQC (b), 31P-NMR (concentration of hydroxyl groups is mmol/g) (c) of structure of KL, SL and WL and major linkages (c) (A) β-aryl ether (β-O-4) linkages: (B) phenyl-coumaran structure (β-5′/α-O-4′); (C) secoisolariciresinol substructure; (D) resinol substructure (β-β); (E) guaiacyl propanol unit.

FIG. 2. XPS wide spectra (a), Cls peaks deconvolution for KL, SL, and WL (b), S 2p peaks deconvolution for SL (c), and Si 2p peaks deconvolution for WL (d).

FIG. 3. Cls deconvoluted XPS spectra of the films (a), Stress-strain curves (b), water contact, and sliding angle (c) SEM images at 50 μm and 5 μm scale (d), water droplet adhesion force study (e), droplet attachment and detachment steps on PU (f) and PKL10 (g) and PWL50 (h), and TGA (i), DTG (j) and Limiting oxygen index (LOI) (f) of PU, PKL10, PWL10 and PWL50 films.

FIG. 4. Coating formulation stability (TSI) for 12h scans (scanning every 30 sec) legend showing the concentration of SL (a), visual of the formulations after 12 h preparation (b), possible illustration of hydrophobic/hydrophilic effect of SL molecules in PWL50 dispersion (c) and water contact value of the films (d).

FIG. 5. Surface morphology, contact angle and appearance of films (a), water absorption (b), UV-Vis transmittance spectra (c) stress-strain curve (d), TGA (c) and DTG (f), limiting oxygen index (LOI) (g) of PS, PKLIOS, PWL10S and PWL50S, digital images for the flame test PU (h), PS (i), and PWL50S of the films.

FIG. 6. Liquid contact angle (a) water contact angle after abrasion (b) of PWL50S coated wood, metal and paper, stability of water contact angle on PWL50S coated wood after thermal exposure at a 200° C. oven and UV-ozone exposure (c), limiting oxygen index and smoke density rating (d) and light absorption (c) of PS, PKLIOS, PWLIOS and PWL50S, flame test on uncoated (f), PU coated (g), and PWL50S coated filter paper (h), uncoated wood (i), PU coated wood (j) and PWL50S coated wood (k).

### DETAILED DESCRIPTION OF A PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

A novel water-based superhydrophobic, flame-retardant, and recyclable PU film was prepared using lignin and PU water emulsion. In two different pathways, KL was utilized to generate a superhydrophobic and flame-retardant material (WL) and a dispersant (SL) for PU formulation. The polymerization of KL and aminopropyl/methyl silsesquioxane (WAPMSS) and the existence of C—O—Si linkage were confirmed by NMR, XPS, and FTIR techniques. Introducing WL (50 wt. %) into an aqueous PU emulsion improved WCA and SA values by 60° and 4°, respectively. In the PU matrix, WL particles formed nano and micro air pockets (as observed via SEM), promoting surface superhydrophobicity. However, due to poor dispersion and aggregation of WL particles, the PWL50 film had substantially lower mechanical strength than pure PU. Interestingly, using SL (0.12 wt. %) as a dispersant increased tensile strength and elongation while maintaining the superhydrophobicity of the PU composite (PWL50S) with a water contact angle of 158+2° and a sliding angle lesser than 10°. SL also enhanced the thermal stability of the composite by 31° C. in the T50% compared to PWL50. In addition, the LOI value increased from 18.5% to 21% when 0.12 wt. % SL was incorporated in PU, and from 24.5% to 25.5% when SL was incorporated in PWL50. Coating wood with PWL50S improved its LOI and increased its hydrophobicity compared to coating wood with PU or PKL10. The superhydrophobicity of coated wood was stable after abrasion and thermal and UV-ozone exposure. The findings of this study demonstrate that lignin may be integrated into PU films at a greater percentage than what has been reported in prior research. Incorporating lignin imparts unique superhydrophobicity, thermal stability, and flame retardancy to the films and wood coatings. In addition, the films exhibit exceptional recyclability when re-processed and cured by a solvent, maintaining mechanical qualities and water contact values. The suggestion that these films can be recycled through solvent processing implies that the new material is less likely to contribute to landfill waste. This, in turn, reduces the environmental impact of PU-based materials and opens possibilities for using this lignin-incorporated PU in other applications beyond coating.

This study presents a concise and environmentally conscious approach for synthesizing water-based PU coating materials incorporating softwood kraft lignin. This approach exploits two separate lignin modifications of a water-based silsesquioxane lignin copolymer (WL) obtained through the copolymerization of kraft lignin with aminopropyl/methyl silsesquioxane (WAPMSS) and a sulfoethylated lignin (SL) achieved via sulfoethylation of kraft lignin with 2-bromoethanesulfonate. The WL was utilized as a superhydrophobic and flame retardant, while the SL served as a dispersant in the PU formulation. In opposition to traditional PU/lignin composites, the composite manufacturing process was solvent- and catalyst-free. The resultant materials with high lignin derivative incorporation (up to 50%) showed superior water repellency, high thermal stability, excellent processability, flame-retardancy and recyclability. Further investigations showed that the resultant material can be utilized in high abrasive environment, while maintaining its superhydrophobicity.

Polyurethane (PU) is widely used as an adhesive, foam, and coating material. However, they pose a higher environmental threat due to higher petroleum by-product content. There is an urgent need to improve PU material's hydrophobic, thermal, and flame-retardant performance while lowering its environmental footprints. Herein, we introduce a new recyclable, water-based, superhydrophobic, flame-retardant PU formulation. In some embodiments, as discussed herein, the coating formulation includes 50 wt. % of water-based silsesquioxane lignin copolymer (WL) as a superhydrophobic component and 0.12 wt. % sulfocthylated lignin (SL) as a dispersant. With the help of 1H-NMR, HSQC, 31P-NMR, FTIR, and XPS analyses, the complete transformation of the hydroxyl groups of kraft lignin (KL) into Si—O—C in WL and the partial replacement of the hydroxyl group with C—O—C in SL were verified. The induced film showed superhydrophobic performance (164°±2 water contact angle and 4°±2 low sliding angle) with a low water droplet adhesion force (80 μN). Flame retardance analysis indicated an LOI value improvement from 18.5% in pure PU to 25.5% in the lignin-containing PU composite (PWL50S). The enhancement of superhydrophobic and flame-retardant characteristics is attributed to SL's homogeneous dispersion of hydrophobic qualities WL within the PU matrix. The superhydrophobic and flame-retardant qualities of the PU film were further verified on wood, metal, and paper surfaces. The durability of the coating's superhydrophobicity was confirmed by sandpaper abrasion. The recycled PU film showed higher strength and modulus while maintaining flame retardancy and superhydrophobicity. This solvent-free PU formulation has superhydrophobic and flame-retardant characteristics, making it a unique material for producing environmentally benign functional coatings.

In some embodiments of the invention, there is provided a method of synthesizing a polyurethane copolymer comprising:
a) mixing a first lignin and a suitable silsquioxane molecule, thereby forming a copolymerized lignin;
b) mixing a second lignin and a base, thereby forming a mixture;
adding a sulfoethylation reagent to the mixture and refluxing the mixture, thereby forming a sulfoethylated lignin; and
recovering the sufloethylated lignin
c) mixing the copolymerized lignin, the sufloethylated lignin and a polyurethane, thereby forming the polyurethane copolymer.

The silsquioxane molecule may be any suitable silsquioxane molecule, for example but by no means limited to aminopropyl/methyl silsesquioxane, aminopropyl/flurosilsesquioxane, aminoethylaminopropylsilsquioxane and minopropyl, vinylsilsquioxane.

The first lignin and the second lignin may be independently selected from kraft lignin, alkali lignin, soda lignin, hydrolysis lignin and lignosulfonate.

The sulfoethylated lignin may be added to the copolymerized lignin and the polyurethane at about 0.05 wt. % to about 0.2 wt. %.

As used herein, “about” refers to the base number plus or minus 10%. That is, “about 100” means “90-110”.

In some embodiments, the sulfoethylated lignin is added to the copolymerized lignin and the polyurethane at about 0.12 wt. %. of the polyurethane copolymer.

In some embodiments, the copolymerized lignin is added to the polyurethane at about 5 wt. % to about 80 wt. % of the polyurethane copolymer.

In some embodiments, the copolymerized lignin is added to the polyurethane at about 20 wt. % to about 60 wt. % of the polyurethane copolymer.

In some embodiments, the first lignin is mixed with the suitable silsquioxane molecule in an aqueous environment.

In some embodiments, the first lignin is about 5 wt. % to about 80 wt. % of the copolymerized lignin.

In some embodiments, the first lignin is about 20 wt. % to about 60 wt. % of the copolymerized lignin.

In some embodiments of the invention, the first lignin and the suitable silsquioxane molecule are mixed, that is, reacted at a temperature of at least about 600C.

In some embodiments, the first lignin and the suitable silsquioxane molecule are reacted for at least about 48 hours.

A lower alcohol may be added with the base, for example, a C1-C4 alcohol, for example, isopropyl alcohol.

The base may be any suitable base known in the art, for example, the base may be NaOH.

While any suitable sulfoethylation reagent may be used, in some embodiments of the invention, the sulfoethylation reagent is sodium 2-bromoethanesulfonate.

The mixture may be refluxed at about 800C for about 2 hours.

The sulfoethylation reagent may be added at about 60% mmol of the second lignin.

The polyurethane may be in the form of an emulsion.

In some embodiments of the invention, a film is prepared from the polyurethane copolymer prepared as described as above.

According to another aspect of the invention, there is provided a method of improving hydrophobicity or the fire retardant properties of an article in need of such treatment comprising coating the article with a polyurethane copolymer prepared according as described above, said article having higher hydrophobicity and/or improved fire retardant properties than an identical article except for the polyurethane copolymer coating.

The article in need of such treatment may be composed of any suitable material, for example but by no means limited to plastic, wood, paper, metal or glass.

The invention will now be described by way of examples; however, the invention is not necessarily limited to or by the examples.

### Example 1-Nuclear Magnetic Resonance (NMR) Analysis

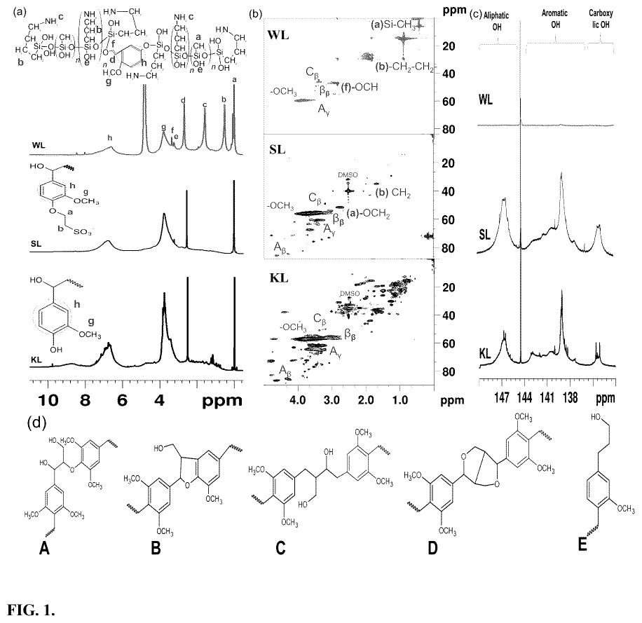

SL and WL were derived from KL through the substitution of phenolic hydroxyl groups with 2-bromoethansulfonate and the replacement of the hydroxyl group with a siloxane bond using aminopropylmethyl silsesquioxane, respectively [26]. NMR study was conducted on KL, SL, and WL to ascertain their respective chemical structures. FIG. 1 (a) illustrates the NMR spectra of the biopolymers, along with the structural representation of a monomeric unit. The resonance attributed to DMSO-d6 is detected at a chemical shift of 2.5 ppm in both KL and SL spectra. Conversely, the resonance associated with D20 is ascribed to a chemical shift at 5 ppm in the WL spectrum. In the 1H-NMR spectra of KL, the aromatic protons exhibit a resonance signal ranging from 6.0 to 7.5 ppm (FIG. 1a-h), whereas the methoxy protons display a resonance signal ranging from 3 to 4 ppm (FIG. 1a-g) [27]. Aliphatic protons can be detected within the chemical shift range of 0 to 3.2 ppm [28]. A novel peak emerged in the oxygenated region at around 3.2 ppm (—O—CH2) for the SL polymer [26]. The prominent peaks observed at 2.7 ppm in WL are attributed to the —OH peaks originating from silicon (FIGS. 1a and e). The signals observed at 1.5 ppm in the spectra of WL are associated with protons originating from NH2 groups (FIG. 1a and 1c). The signals observed at a chemical shift of 0.5 ppm are associated with the propyl structure of protons originating from the CH2—CH2—CH2 group (FIGS. 1a and 1b). The signals detected at 0 ppm are attributed to the proton of CH3 that is coupled with Si (a) [29]. The 1H-NMR spectra of the SL and WL polymers exhibit the presence of the aromatic (h) and methoxy (g) protons derived from KL (FIG. 1a). Nevertheless, the prevalence of aliphatic-H is more pronounced in WL than in SL, which is the result of long aliphatic chains originating from WAPMSS in WL, while SL only had one ethyl group.

The HSQC NMR analysis was conducted on KL, SL, and WL samples to reveal interconnections and identify the primary group constituents, as depicted in FIG. 1 (b). The cross-peak signals of δC/δH at 71.4/4.7 ppm, δC/δH at 53.29/3.44 ppm, and δC/δH at 53.6/3.0 ppm were observed in KL, SL, and WL polymers, indicating the presence of substantial interunit linkages in β-O-4 (AB), β-5 (BB), and β-β (CB) (FIG. 1d), respectively [30]. In addition, the distinctive signal corresponding to the methoxy (—OCH3) functional group was observed at the chemical shift of δC/δH 55.5/3.70 in FIG. 1 (b) [31]. The HSQC spectra offer distinct evidence of major linkages (β—O-4′, β-5′, and β-β) and major units (secoisolariciresinol substructure, resinol substructure, and guaiacyl propanol unit) and methoxy structures in KL, WL, and SL. This finding is consistent with the results obtained from 1H-NMR analysis, indicating that both WL and SL kept the original structure of KL. In the context of the SL structure, the cross-peak signals seen for the δC/δH of 50.7/2.8 and 32.2/1.8 ppm correspond to the functional groups of —OCH2 and CH2, respectively [32]. This further confirms the presence of strong ethyl groups in the structure of SL because of sulfocthylation. The WL spectrum exhibited aliphatic linkages, which can be attributed to the silanization inherited from the WAPMSS. A novel cross-peak signal was also detected in the WL within the C—O linkage region at the δC/δH of 46.2/3.2 ppm. This signal represents the formation of a new chemical bond (C—O—Si) between KL and WAPMSS. This bond is produced through a condensation reaction involving WAPMSS and KL [33].

The quantitative 31P-NMR spectra of KL, SL, and WL following phosphorylation are depicted in FIG. 1 (c). The proportions of aliphatic, aromatic (C-5 substituted and guaiacyl), and carboxylate hydroxyl (OH) groups present in the samples are quantified. The hydroxyl group content of the SL polymers was lower than that of KL, whereas no hydroxyl groups were discernible for WL (FIG. 1c). The decrease in the overall number of hydroxyl groups in SL provides evidence for the successful transformation of the hydroxyl groups of KL, which is further corroborated by the presence of C—O—C connections in HSQC NMR analysis. Similarly, the silanzation process led to the full conversion of hydroxyl groups of KL for WL production (FIG. 1).

### Example 2-X-Ray Photoelectron Spectroscopy (XPS) Analysis

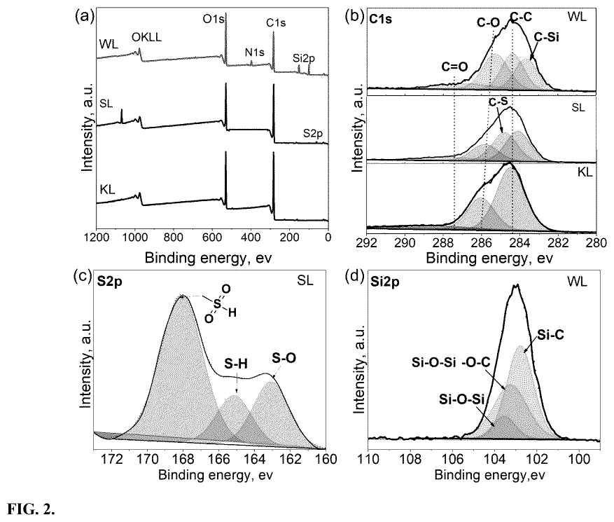

XPS investigation revealed the elemental compositions and chemical bonding characteristics of KL, SL, and WL. The elemental compositions of KL consisted of carbon (285 cV) and oxygen (532 eV), and impurity traces of sulfur (166.5 eV) [34]. FIG. 2 (a) revealed the presence of sulfur (166.5 eV) in SL, as well as nitrogen (400 eV) and silicon (152.9 cV and 101 eV) in WL [35]. FIG. 2 (b) displays the core level spectra of Cls, along with a fitting analysis for the peaks associated with carbon bonds. The deconvolution of the Cls peaks for KL yields three primary components of C—C(284.8 cV), C═O (288-290 cV), and C—O (286 eV) [36]. Similarly, an examination was conducted on the Cls spectrum of SL, resulting in the identification of a new C—S peak at 284.8 eV [32]. In examining WL's Cls, the carbon links of particular significance involved carbon and silicon (C—Si) at an energy level of 283 eV. In contrast to KL, a notable reduction in the concentration of O═C—O bonds was observed in the WL, but the concentration of O—C bonds exhibited an increase in the WL. This observation implies that the reaction involves the possible OH reactive sites, which aligns with the findings from 31P-NMR (FIG. 1b) and FTIR studies. Furthermore, it can be observed that the WL exhibited higher C—O bonds than the KL. The formation of a new C—O—Si connection between KL and WAPMSS can be attributed to the polycondensation reaction. This observation aligns with the findings of the HSQC NMR investigation, which revealed a notable augmentation in aliphatic C—O bonds.

In addition, the S2p peaks of SL were subjected to deconvolution, and the outcomes are presented in FIG. 2 (c). The three components under consideration are denoted as S═O (168 cV), S—H (163 CV), and S—O (165 eV). This finding, along with the FTIR, 1H NMR, and HSQC NMR, confirm the successful sulfoethylation of KL to produce SL.

The deconvolution of Si 2p peaks for WL is illustrated in FIG. 2 (d). The Si 2p spectrum of WL exhibits distinct components corresponding to Si—C(101.34 eV), Si—O—Si/Si—OH (103.76 eV), and Si—O—C(102.5 eV) [37]. The results align with the outcomes derived from FTIR analysis, where the WL spectra show higher transmittance peaks of Si—C, Si—O—Si, and Si—O—C. The identification of Si—O—C bonds on the XPS and FTIR spectra, along with the detection of C—O linkages in the HSQC spectrum and the reduction in hydroxyl groups observed in the 31P-NMR spectrum, provide conclusive evidence of the copolymerization and conversion of lignin's hydroxyl groups (due to silanization) for WL production.

### Example 3-Formulation Stability

The assessment of the coating formulation's stability provides insights into its constituents' interactions and the formulation's shelf life [38]. The formulation was prepared by combining a PU water emulsion with varying proportions of WL or KL. The five samples have been shown to have dispersion stability (i.e., TSI global index) for over 12 hours. There exists an inverse relationship between the stability of a coating formulation and the TSI value, whereby an increase in stability corresponds to a decrease in the TSI value [39]. The PU emulsion was stable as evidenced by a TSI value of 2. Adding KL led to an increase in the TSI value, suggesting a less stable system. Similarly, the inclusion of WL polymer in the PU emulsion system led to a significant rise in the TSI value. The comparative dispersibility of KL and WL in a PU system is notably better for KL, as demonstrated by the TSI result and verified through visual examination. This suggests that the WL particles possess greater hydrophobic interaction, resulting in their aggregation and sedimentation.

### Example 4-Performance of Films

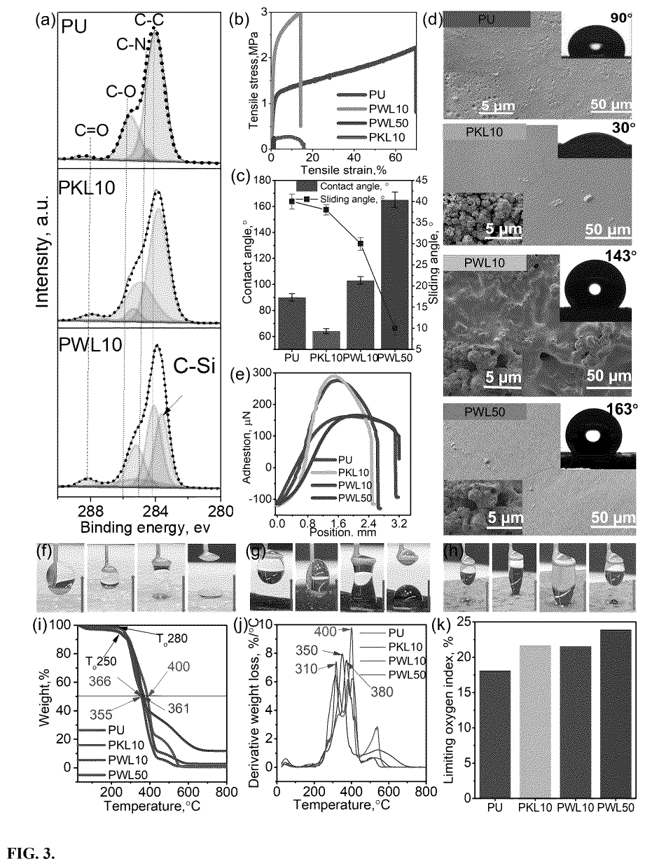

The examination conducted by XPS focused on analyzing the elemental compositions and chemical bonding characteristics of the films. Specifically, those of PU, PKL10, and PWL10 these samples were selected to have similar concentrations of KL and WL-containing films in FIG. 3a. The deconvolution of the Cls peaks corresponding to the PU and PKL10 results in the identification of four main components: C—C(284.8 cV), C—N(286.2 eV), C═O (288-290 e V), and C—O (286 eV) [40]. The percentage area concentration of the C═O bond on PU is 2.10, whereas PKL10 has a concentration of 3.82. A considerable number of C═O bonds may indicate the existence of carboxylic-OH groups, which are notably abundant in the KL structure (FIGS. 1b and 2b). An extra component, C—Si (283 eV), was observed in the deconvolution of PWL10. The presence of a C—Si bond in PWL10 indicates the existence of Si—CH2 structural components originating from WL due to copolymerization (FIG. 2b). FIG. 3b displays the stress-strain curves for the films. The PU sample with more than 10 wt. % KL displayed disintegration and fragility, making it impossible to analyze the mechanical properties. Insufficient film formation of KL at a greater concentration is caused by agglomeration due to significant self-interaction [41]. Compared to PU, the WL and KL composite films exhibited reduced tensile strength and elongation at break. However, incorporating lignin polymer resulted in an increased modulus, indicating that the produced films were more rigid. Previous research has confirmed the occurrence of reduced tensile strength and elongation in PU films when the proportion of KL surpassed 3% in the film [14a]. Water contact angle (WCA) and sliding angle (SA) analysis was carried out to determine the superhydrophobic and hydrophobic characteristics of the films in FIG. 3c. The WCA and SA values of the pure PU were measured to be 90° and 40°, respectively. By including 10 wt. % KL into the PU matrix, the film exhibited a reduction in its WCA value by 35°.

Compared to the PU film, the hydrophilicity of PKL10 films may be attributed to a free carboxylic group inside the PKL10 film structure (FIG. 3a). However, the water contact angle of PWL10 composites exhibited a 30° increase compared to pure PU. Furthermore, when the content of WL increased in the PU film, the water contact angle increased while the SA decreased progressively. The PWL50 film exhibited the maximum WCA value of 163° and a low SA of 8°. The enhanced hydrophobicity of WL-containing films in comparison to PU may be attributed to the inclusion of a C—Si component in the PWL10 and PWL50 films (FIG. 3a), as well as the decreased concentration of C—O (0.6% area) [42].

To enhance comprehension and establish a connection between the surface morphology of the films, a study by SEM was conducted (FIG. 3d). The surface of PU films was relatively smoother than that of PKL10 or PWL10. When KL particles were introduced to the PU matrix, the film surface exhibited microscopic clusters and clumps of particles. However, a more detailed examination reveals that these clusters were spherical aggregates. Conversely, PWL10 films exhibited higher polymer aggregation forming nano and micro air pockets. The decreased dispersibility of the WL within the PU matrix is the cause of this discrepancy. The PWL10 and PWL50 films contained spherical macroscopic particles associated with smaller particles and air pockets. These results can be ascribed to the film's heightened hydrophobic nature and coating. Incorporating 50 wt. % of WL into the PU matrix led to a smoother surface than incorporating 10 wt. % of WL (FIG. 3d). Particle aggregates arranged diagonally on the PWL50 film were detected at reduced resolution, potentially contributing to the film's decreased mechanical characteristics (FIG. 3b). The poor dispersion of WL in the PU matrix suggests inadequate interfacial adhesion between the polymer matrix (PU) and WL, leading to reduced mechanical load transfer from the polymer matrix to WL and consequently resulting in poor mechanical characteristics of the overall film [43].

Tensiometer measurements of water adhesion force was utilized to quantify the coatings' water adhesion force (FIG. 3e). The droplet profile was captured by digital camera and presented in FIG. 3f-h. The instrument stage supports the suspended droplet when it contacts the sample on the stage, resulting in a considerable decrease in force. As the stage drops, the force rapidly increases until it peaks. The PU and PKL10 films had detachment peaks at 1.5 and 2 mm, with 250 and 285 μN pull-off forces. Like PWL50, the superhydrophobic film exhibits a detachment peak of 0.12 mm and a pull-off force of 80 μN. Hydrophobic surfaces, once separated, show a notable decrease in the adhesion force, indicating that half of the droplet remains on the surfaces [44], as shown with PU and PKL10. Conversely, PWL50 restored their water adhesion force to zero. This shows such surfaces' extraordinary water-repellent and low water adhesion properties [45]. The water droplet exhibited a strong adhesion to the surface of the PU (f) and PKL10 (g) films. However, the droplets could quickly detach from the PWL50 film (h). Films incorporated with WL exhibited high water repellency and resistance to water adhesion. This phenomenon may occur due to the copolymerization process, which would replace the hydrophilic hydroxy groups of lignin with hydrophobic silsesquioxane groups (FIG. 1). The WCA and SA (FIG. 3c) and SEM (FIG. 3d) revealed the presence of a hierarchical structure at both the micro and nano levels, contributing to the enhanced superhydrophobic characteristics.

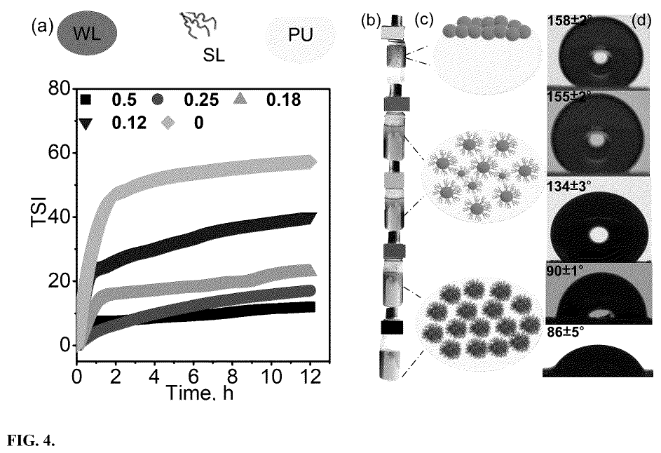

The thermal stability of PU, PKL10, PWL10, and PWL50 were investigated by TGA analyses, as shown in FIGS. 3i and 4j. The films' thermal stability was assessed by the onset temperature (To), 50% weight loss temperature (T50%), and maximum decomposition temperature (DTGmax). PU showed To at 280° C. and T50% at 355° C. PKL10 had a T50% and DTGmax that were 45 and 20° C. higher than those of PU, respectively. Incorporating KL in the PU matrix significantly enhanced the thermal stability of the film. Adding more hard segments (lignin) could result in the formation of crosslinks, leading to higher char production and enhanced interaction between the PU matrix and KL polymer [1,6a]. The T50% value of PWL10 decreases by 10° C., whereas the DTGmax occurred 40° C. lower than PU. Poor WL dispersion causes aggregation in the PU matrix (FIG. 3d). Agglomerations or clusters may cause film flaws or voids, and faults or voids in the PWL10 and PWL50 layer may cause thermal deterioration [46]. The poor dispersion of WL may reduce the contact area and interaction between the WL and the PU matrix, reducing WL thermal barrier characteristics. Similarly, PWL50 film has a DTGmax of 350° C., i.e., 20° C. lower than PU film in FIG. 4j. Due to WL's inorganic component, PWL50's ultimate weight residue was 17% greater than PU's.

The LOI values of the films are illustrated in FIG. 4k. The pure PU had the lowest LOI value of 18.4%, while the PWL50 had the highest LOI value of 25.4%, exceeding the values of the other samples. The PU films containing WL had a higher LOI than PU and PKL10 due to enhanced charring properties of WL, as shown by TGA analysis. A silsesquioxane structure on the KL backbone provides thermal protection to charring, lowering flammability at high temperatures. When incorporated into the PU polymer, silsesquioxane would delay ignition and strengthen the PU matrix [47]. The WL polymer in water-based PU emulsion exhibited superior hydrophobicity, thermal stability, and flame-retardant features when utilized in a high concentration (50%), surpassing the performance of pure PU or PKL10 coating materials. Nevertheless, the mechanical characteristics of this film were significantly inferior to those of PU or PKL10 due to the inadequate dispersibility of WL in the PU matrix. Hence, an attempt was made to enhance the dispersibility of WL in the PU matrix through the utilization of SL as a dispersant in the following section.

### Example 5-Effect of SL on the Stability and Surface Chemistry of PWL50 Formulations

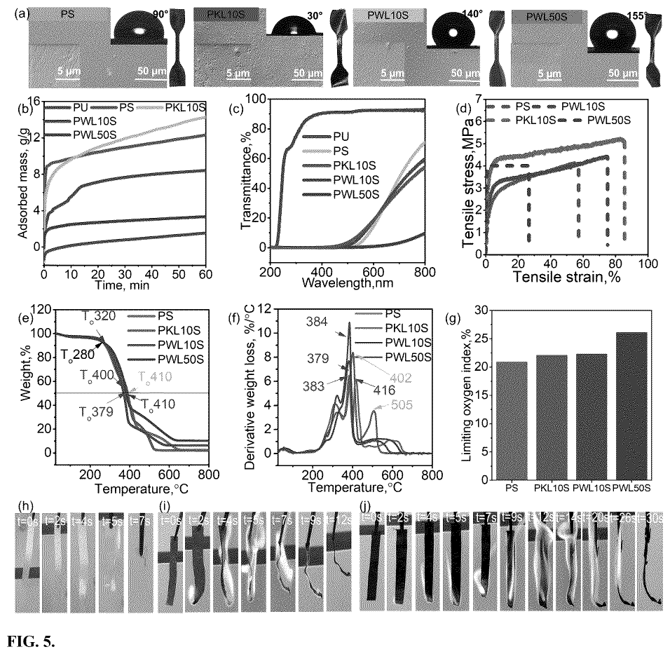

The effect of SL on the stability and surface properties of PWL50 formulation was investigated, and the results are shown in FIG. 4a-d. FIG. 4a shows that the lack of SL in the PWL50 sample led to instability with the TSI value of 55. The high molecular weight and hydrophobic character of WL particles may stop their dispersion in PU due to their agglomeration. Adding 0.12 wt. % of SL to PWL50 increased dispersion stability by 25% and adding more SL to the dispersion improved its stability further. However, the surface became more hydrophilic. These effects have also been found in previous investigations involving the utilization of sulfonated lignin as dye dispersants [48]. Dispersants reduce particle agglomeration by introducing steric hindrance and electrostatic forces. Due to its high surface charge density (2.1 mmol/g), SL adsorption onto WL particles could prevent WL agglomeration by electrostatic repulsion (FIG. 4c). Introducing SL at lower concentrations (0.12 wt. %) resulted in sustained superhydrophobicity with a contact angle of 155° (FIG. 5d). As a result, 0.12 wt. % of SL was selected as a dispersant for the formulation development.

### Example 6-Effect of SL on the Properties of PU Films

The effect of SL dispersant on the surface morphology, mechanical properties, and thermal properties of WL and KL-containing films were investigated, and results are presented in FIG. 5. FIG. 5a illustrates the appearance and the surface morphology of films generated with the addition of 0.12 wt. % SL. The addition of SL in a pure PU (PS) emulsion changed the color from clear to brown, and small aggregates was detected in the film, and the WCA remained 90°. Similarly, SL was incorporated in the KL and WL containing formula, where its addition improved the film's appearance while not affecting the water contact angle values crediting the optimization of SL in FIG. 5a. The overall absorption of water by the films were also analyzed by tensiometer as shown in FIG. 5b. PKL10S and PS exhibit the most water absorption, with values of 12.8 g/g and 11.8 g/g, respectively. PU has a lower water absorption compared to PKLIOS and PS. On the other hand, PWL10S and PWL50S have the lowest water absorption, with values of 1 g/g and 2.1 g/g, respectively. The reduced water absorption of PWLIOS and PWL50S can be ascribed to the films' higher water contact angle (WCA) values (FIG. 3a and FIG. 5a) and the hydrophobic characteristics of WL. The greater water absorption of PWL50S, as opposed to PW10S, can be attributed to the exposure of the PU matrix in PWL50S, which is caused by the porous nature of the film.

FIG. 5c shows the UV-transmittance spectra of the films; the PU films show more than 68% in the UVC (190-275 nm) regions, 78% transmittance in the UVB (275-320 nm) regions, 90% transmittance in the UVA (320-380 nm) regions. The films containing PS, PKL10S, PWLIOS, and PWL50S show 100 percent protection in the UVA, UVB, and UVC, as shown by 0% transmittance in the regions. The superior UV-shielding property resulted from the abundant phenolic hydroxyl groups concentrated in the outer surface of KL, SL, and WL particles (FIG. 1 and FIG. 2). Additionally, the complex structure of lignin allows for the scattering and absorption of UV light that penetrates the film, resulting in reduced transmittance [49].

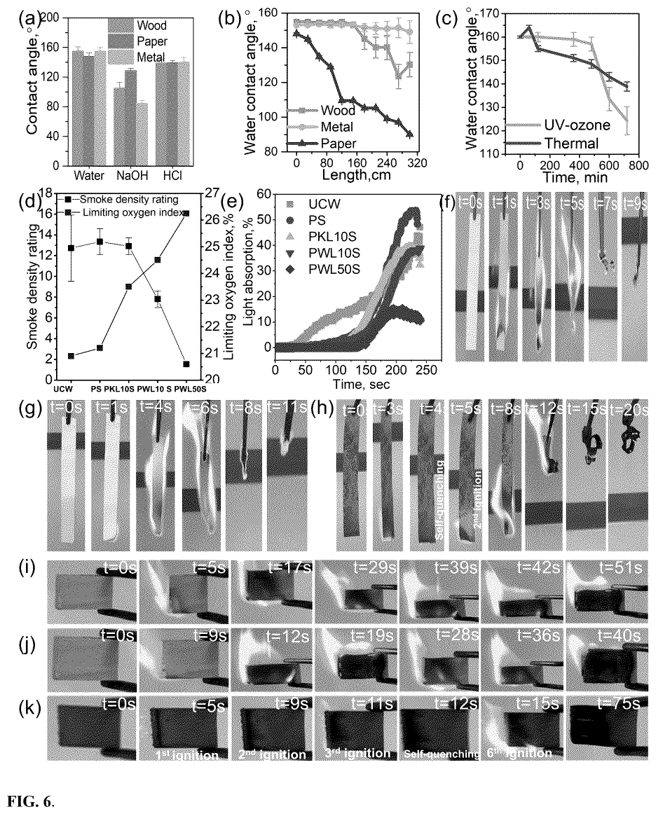

The stress-strain curve, tensile strength and percentage elongation of PS, PKLIOS, PWL10S, and PWL50S composite films are presented in FIG. 5b. Compared with films prepared without SL, the films generated with SL had a higher modulus and tensile strength. Incorporating SL in the pure PU film improved the tensile strength by 2.5 MPa. The structural component of SL consists of many aromatic structures (FIG. 1) that strengthen the films as rigid segments. PKL5S showed the highest tensile strength (35 MPa). Similarly, the PWL5S films improved tensile strength by 8 MPa compared to PWL5. This improvement in the tensile strength is attributed to the improved dispersion of WL and KL particles in the PU system in the presence of SL (FIG. 6a). The mechanical strength of PU films is enhanced when they contain a higher concentration (5% and 10%) of KL in the presence of SL, as compared to a similar concentration with WL. There could be a possible reaction between KL's hydroxyl groups (FIG. 1c) with isocyanate groups to generate urethane bonds and be the reason for the improved mechanical strength 50. This phenomenon is not true for WL since siloxane groups occupy the hydroxyl groups (FIG. 1c). However, when the concentration of KL increased more than 10%, the tensile strength dropped even in the presence of SL. Consequently, producing a PU film with a concentration exceeding 10% in KL material was deemed unattainable. Nevertheless, it was possible to produce a film with higher concentrations of WL (25% and 50%) despite the subsequent reduction in mechanical properties.

Furthermore, it can be observed that the elongation at the break of PS film is comparatively lower than that of PKL10S and PWL10S. Additionally, the elongation at the break of KL and WL-containing films (in the presence of SL) exhibits a steady drop as the KL or WL content concentration increased. The increase in KL or WL in the PU matrix would increase the hard segment of the PU composite matrix, which would reduce the PU film's affinity to deform under stress, making it more brittle with a decrease in elongation at break [50,51].

The thermal stability of PS, PKLIOS, PWLIOS, and PWL50S was investigated, and their TGA and DTG curves are depicted in FIGS. 5e-f, respectively. Except for PWL50S, which exhibited a 60° C. rise in the To compared to PWL50 (FIG. 4i-j), the remaining samples did not demonstrate an increase in the To. This result indicates that the introduction of SL had no impact on the thermal resistance of PKL10 or PWL10 but had a notable effect when the concentration of WL was higher. The enhanced To of PWL50S can be due to the enhanced dispersion of WL in the PU system because of SL (FIG. 4a). Notably, in the absence of SL in the formulation, the To was significantly lower (FIG. 5a). The SL films demonstrated elevated temperatures at T50% compared to the formulation without SL.

The experimental findings demonstrated 24, 10, 44, and 54° C. temperature enhancements in DTGmax for PS, PKLIOS, PWLIOS, and PWL50S. This indicates that more energy is needed to break KL or WL's interaction with PU chemical chains in the presence of SL. The inclusion of SL also improved the DTGmax for all the films. Nevertheless, the DTGmax of PKL10S exhibited a higher increase than PWL10S and PWL50S. SL in the PU matrix increased the composite film's KL and WL dispersion and increased the presence of the stiff phenylpropane aromatic rings. This improved thermal stability by increasing char formation. Typically, the dense organization of lignin inside the PU matrix can significantly improve the heat resistance of films [52]. It is worth mentioning that WL particles were also beneficial for increasing the residual weight of the PU films, as expected.

After SL was incorporated into the PU films, the LOI value was investigated for samples PS, PKLIOS, PWLIOS, and PWL50S. The PS film demonstrated a 2.8% increase in LOI compared to pure PU. The LOI value for PWL50S showed a 2.2% improvement compared to the sample without SL. This improvement in the LOI value is attributed to well-dispersed SL in the PU matrix structure (FIG. 4a). This finding can also be supported by the improved thermal stability resulting from TGA analysis (FIG. 5e-f). The flame test was conducted to replicate a real-life fire on PU, PS and PWL50S, and the outcome is illustrated in FIG. 5h-j. When exposed to propane gas, PU underwent a consistent and sustained igniting, with a flame that completely burned the sample within 7 s. PS samples took 12 s for the flame to propagate and reach the film's end, but unlike PU, the PS samples left the film's structure intact after the flame was extinguished in 12 s. This indicates that the introduction of SL in the PU matrix, even at 0.12 wt. % concentration, improved the stability of the film when burned, as indicated in the TGA and LOI analysis (FIG. 5e-g). The PWL50S films, on the other hand, took 30 s for the flame to reach the film's end from the ignited tip on the 2nd ignition, and after the flame reached the top, the film still hung without losing its structural integrity. This stability of PWL50S for flame is attributed to the highest concentration (50%) of WL, which has a high thermal stability.

### Example 7-Performance of PU Based Formulations as a Coating in Different surfaces

The formulation exhibiting superhydrophobic properties (PWL50S) were coated in wood, metal, and paper, and contact angles were measured and reported with different liquids (FIG. 6a). The coated surfaces show a contact angle higher than 150° exhibiting the superhydrophobic characteristics of the formulation. The contact angle slightly changed for a droplet of 0.1M NaOH while showing a similar contact angle for 0.1M HCl liquids. The reduced contact angle for NaOH droplets could be a result of the ionization of lignin's acidic groups (phenolic hydroxyl groups), and the break down of the ether bonds resulted from the presence of higher alkyl chains on WL (FIG. 1) [53]. The durability of a superhydrophobic coating is dependent on its abrasion resistance [54]. To enhance the practical applicability of the generated product, the superhydrophobic formula (PWL50S) coated wood, metal, and paper underwent sandpaper abrasion testing, and the water contact angle after abrasion is reported in FIG. 6b. The coating withstands up to 160 cm of abrasion for wood and metal before the contact angle drops, while the coated paper superhydrophobicity failed after 60 cm. The potential cause for the stability of the superhydrophobicity on wood and metal is attributed to the strong adhesion of the coating formulation due to the sticky nature of PU on metal and wood. At the same time, the paper itself lacks mechanical strength [55]. Following the 160 cm abrasion, the contact angle decreased for wood, but the superhydrophobicity remained unchanged on the metal surface until 320 cm of abrasion. These phenomena can be explained by separating the coating from the underlying wood substrate, which then exposes the wood surface directly to water droplets. The presence of the coating on the metal surface may be attributed to the metal's superior mechanical qualities compared to wood.

The coated wood exhibits excellent stability of its superhydrophobic quality even after being subjected to heat deterioration at 200° C. and exposure to UV-ozone for up to 200 min (FIG. 6c). Furthermore, these properties stay above 100° of WCA even after 800 min of exposure. The stability of the superhydrophobic coating on wood, when exposed to thermal and UV radiation, is attributed to the thermal stability of WL and its ability to absorb 100% of UV rays. This conclusion is based on the findings of TGA and UV-Vis transmittance analysis. These properties enable the coating to retain its superhydrophobicity and shield the coated wood from thermal and UV degradation.

Additionally, the fire-resistant properties of the formulations were evaluated by applying them to a wooden surface and measuring the LOI and smoke density. The LOI, SDR and light absorption curves for uncoated wood, PS, PKLIOS, PWLIOS, and PWL50S coated wood are shown in FIG. 6d-e. Concentrated smoke reduces perceptibility, limiting egress and injuring those trying to evacuate [56]. The smoke generation level of materials is a significant focal point in assessing fire safety risks [57]. FIG. 6e shows how light absorption in uncoated wood increased when lit and stabilized as it burned. Peak light absorption was 50%, and smoke density was 18 at 250 s (FIG. 6d). Wood coated with PU had a peak light absorption of 55% and a smoke density of 15. Due to their high flammability, PU coatings are unsuitable for naturally flammable wood coatings. Utilizing PWL10S or PKL10S did not increase smoke production in the coated wood. Smoke output decreased when WL was increased to 50. This was supported by 29% light absorption and 4 smoke density. The results indicate that WL greatly reduced wood combustion. PWL50 may create a crosslinked ceramic phase during burning, reducing the combustion rate. This phase prevents the fire from spreading and preserves the wood's structure.

Flame tests were performed on uncoated paper and wood samples, coated with PU, and coated with PWL50S (FIG. 6f-k). Uncoated and PU-coated paper burn rapidly, with the flame consuming the paper in around 9 and 11 s, respectively. In contrast, PWL50S-coated paper self-extinguishes upon first ignition, and it takes 20 s for the flame to spread and reach the end of the paper. Additionally, a noticeable paper residue remained at the end of the experiment. Uncoated and PU-coated wood immediately catches fire and burns completely at 51 and 40 s ignition, respectively (FIG. 6i-k). However, due to its self-quenching properties, the PWL50S coated wood required a 6th ignition. Even after the 6th ignition and 75 s of burning, the flame did not devour half of the coated wood. The self-quenching property exhibited by both paper and wood may be attributed solely to the flame retardant and thermal stability of the PWL50S coating formulation, as demonstrated in the film and flame test (FIG. 5j), as well as the higher thermal stability of WL and the charring characteristics of lignin.

### Example 8-Recyclability of PU Films

The manufacture of PU is criticized for generating non-biodegradable waste in landfills, mostly because of the permanent interconnected structure of PU crosslinks. Nevertheless, the hydroxyl and carbamate groups from separate polymer chains can engage in transcarbamoylation processes, creating dynamic covalent networks [58]. These networks can undergo reversible formation and cleavage, providing PU with excellent solvent processability [59]. The recyclability of the PU films was examined by cutting the cured samples into smaller pieces and dissolving them in DMF. The dissolved material was casted and cured. Table 1 displays the tensile strength, elongation at break, modulus and water contact angle of the original and recycled films. The films are often recyclable, due to the advantageous presence of a significant amount of hydroxyl groups in lignin. The hydroxyl groups quickly engage in transcarbamoylation interactions with carbamate groups in a suitable solvent, leading to the swift restoration of covalent cross-linking networks [59]. Furthermore, the findings demonstrate that recycled films had enhanced tensile strength and modulus while the elongation percentage dropped. Enhanced characteristics of tensile strength and young modulus improvement of the films after reprocessing, as opposed to the virgin samples, may be attributed only to the improved compatibility of the dispersion medium DMF rather than water, which was used for the virgin films generation, which led to the generation of stiffer films as indicated by young modulus which lead to reduced elongation percentage. Interestingly, the recycling did not affect the contact angle of the WL-containing PU films.

### Example 9-Implications

The primary focus of research on PU polymers revolves around the following problems. 1. Increasing the use of bio-based polymers in PU synthesis. 2. Enhancing the thermal stability. 3. Increasing the hydrophobicity of PU materials [10]. One of the major issues of including biopolymers in PU is that the performance of the final material, such as hydrophobicity, drops significantly [60]. The only documented studies for enhancing PU films' water contact angle values include formulations mostly composed of non-bio-based ingredients, such as silicide and fluoride [61]. The literature indicates that lignin is used as a filler in the production of PU film. However, the amount of lignin used is limited to 5 wt. % due to the adverse impact on PU qualities as the lignin concentration increases, as shown in Table 2. The study described in this paper employed around 50.12 wt % of modified lignin (WL and SL). Based on the yield of WL and SL, the total KL utilized is estimated to be around 25.06 wt %, significantly greater than previously reported (Table 2), with a much superior hydrophobicity, thermal stability, and flame retardancy (FIG. 6). A Further noteworthy finding of this study is that KL at a concentration of 10% was integrated into a PU film with the assistance of a lignin-based dispersant SL. This indicates that the film-forming ability of lignin may be enhanced not only by modification but also by using and employing a lignin derivative as a dispersant, particularly when utilized in higher concentrations.

### Example 10—Materials

Kraft lignin (KL) was obtained from FPInnovations and produced via LignoForce technology. Aminopropyl/methyl silsesquioxane (WAPMSS) was purchased from Gelest Inc. USA. Sodium 2-bromoethanesulfonate, sodium hydroxide (NaOH), deuterated sodium hydroxide (NaOD), deuterium oxide (D20-d2), deuterated dimethyl sulfoxide (DMSO-d6), hydrochloric acid (HCl) 37%, sodium hydroxide (NaOH), 2-chloro-4,4,5,5-tetramethyl-1,3,2-dioxaphospholane (TMDP), chloroform (CDCl3), ethanol (95%), pyridine, cyclohexanol (99%), chromium (III) acetylacetonate (97%), dimethylformamide (DMF), poly tetrahydrofuran (PTMG, Mw of 2000 g/mol with hydroxyl value of 204 mmol g-1) and isophorone diisocyanate (IPDI) were all purchased from Millipore Sigma, Oakville, Canada. Also, nylon membrane syringe filters with 0.45 μm pore openings, filter papers were purchased from Fisher Scientific, Ottawa, Canada. A dialysis membrane (1,000 g/mol cut-off) was obtained from spectrum labs. Stain grade pine wood, and metal sheet were purchased from Home Depot, Canada.

### Preparation of KL-WAPMSS (WL) Polymer

The polymerization of KL and WAPMSS was conducted in an aqueous environment following the polycondensation reaction [17]. KL (1 g, 5.5 mmol) was dispersed in deionized water (40 mL) in a three-neck flask to make a 25 gL-1 of lignin suspension in deionized water. The suspension was kept stirring for 1 h. Then, WAPMSS solution, 20% in water (9 mL, 5.5 mmol), in a 1:1 molar ratio of KL: WAPMSS, was fed into the reaction medium. The reaction was initiated by transferring the three-neck flask to a preheated water bath at 60° C., while mixing at 250 rpm. The reaction medium was cooled to room temperature upon reaction completion (i.e., after 48 h). The product was centrifuged and washed three times with toluene to remove any remaining unreacted chemicals. The supernatant, i.e., copolymerized lignin, was resuspended in water, and the suspension was neutralized with 1M of HCl, followed by dialysis for 24 hours, and dried in a standard oven at 60° C. for 48 hr. The product of this process was KL-WAPMSS polymers which was denoted as WL in this work.

### Preparation of Sulfoethylated Lignin (SL)

The sulfoethylation of KL was carried out following the literature [18]. To synthesize sulfoethylated lignin, KL (1.5 g, 5.5 mmol) was dispersed in a mixture of isopropyl alcohol (45 mL) and NaOH (12 mL, 30 wt. %) at room temperature and stirred (250 rpm) for 30 min in a three-neck flask. Then, a sulfoethylation reagent (1:0.6 mmol ratio of KL: sodium 2-bromoethanesulfonate) was added to the mixture and refluxed in continuous cold water at 80° C. for 2 h. Afterward, the reaction product was washed several times with ethanol/water (40/10 vol/vol) and recovered by centrifugation at 3000 rpm for 5 min. The precipitates were dissolved in deionized water (50 mL) and purified using dialysis for 2 days. After purification, the collected products were dried in a conventional oven at 60° C. until a constant weight was obtained.

### Synthesis of PU emulsion

The synthesis of PU was conducted following the procedure outlined in the literature [14a]. Initially, PTMG (20 g) and IPDI (11.04 g) were introduced into a desiccated three-neck flask. Subsequently, the flask was immersed in an oil bath and subjected to mechanical stirring at 200 rpm. At 85° C., acetone (5 mL), DMBA (2.03 mL), and DBTDL (20 μL) were introduced into the flask, and the system was kept for 1 h. Subsequently, 1,4-butanediol (BDO) (1.42 g) was introduced to the system, and the mixture was stirred at 200 rpm using a mechanical stirrer for 3 hours. Every hour, acetone (5 mL) was introduced into the reaction system to maintain the system's viscosity low. Subsequently, the mixture was subjected to cooling until it reached a temperature of 60° C. Afterward, a quantity of triethylamine (1.38 g) was introduced to the flask, and the reaction proceeded for 0.5 h. After the reaction, the mixture was emulsified by adding deionized water at a concentration of 40 g/L and agitating it with a magnetic stirrer at 250 rpm for 4 hours.

### Formulation

A specific quantity of WL powder and PU emulsion was introduced to a dried vial. Then, the blend was vortexed at a high speed for 5 min, followed by magnetic stirring at 500 rpm for 5 h at room temperature. The mixture was named PWLx, where x represents the weight percentage of WL (3%, 5%, 10%, 25%, and 50%) in the formulation. Control samples were prepared using KL and pure PU emulsion following the same procedure.

In a different set of experiments, SL was utilized as a dispersant, and it was added directly to the prepared blend of PWL50, vortexed at high speed for 5 min, and followed by homogenization using ultrasonic machine (Omni-Ruptor4000, Omni International Int.) at room temperature, 240 W power, and 30 sec with 3 sec intervals. A varied amount of SL (0.12 wt. %, 0.18 wt. %, 0.25 wt. %, 0.5 wt. % based on the total weight of the formulation) was added to the system to study the effect of dispersant concentrations in the formulation. The optimal concentration of SL in the formulation was determined by conducting a suspension stability test using a Turbiscan lab expert following Turbiscan stability index (TSI) and water contact angle analysis, and this concentration was subsequently utilized in all the samples. The samples were labeled as PWLxS, where x denotes the weight percentage of WL (3%, 5%, 10%, 25%, and 50%). S denotes the optimized concentration of SL (0.12 wt. %).

### Film Casting and Coating

For film generation, the formulation mixture was poured into a silicon mold, cured into a film at 55° C., and then dried at 120° C. for 2 h. On the other hand, a formulated solution was applied onto a wooden, metal and filter paper substrates. Before applying, the wood and metal surfaces were thoroughly cleaned with deionized water and then dried in an oven at 60° C. for 2 hours. The wood, metal and filter paper samples were immersed in the prepared coating solution for 5 min and then subjected to a curing process at 120° C. for 2 h. The control samples consisted of uncoated samples and PU.

### Recycling

The recycling of the films was evaluated by inserting the cured films into a vial containing a DMF solvent and subjecting to magnetic stirring at 250 rpm for 24 h. Subsequently, the films were produced following the procedures outlined in section 2.6 and retested comprehensively.

### Characterization

### Structural Analysis of KL, WL and SL

KL, WL, and SL were investigated for their chemical structures using proton nuclear magnetic resonance (1H-NMR), heteronuclear single quantum coherence NMR (HSQC) and 31P-NMR [19], using top spin 4.02 software (Bruker AVANCE Neo NMR-500 MHz apparatus USA). The analysis details, conditions, and sample preparation are stated in supporting information. The chemical compositions of lignin polymers (KL, WL, and SL), PU films and PU composite films were examined using an XPS analyzer (Kratos AXIS Supra, Shimadzu Group Company, Japan) with a dual anode AL/Ag monochromatic X-ray source (1486.7 eV). Samples were put through XPS on a double-sided carbon tape after being oven-dried at 60° C. Steps, dwell, and sweep times were 230, 260, and 60 s. ESCApe™ (1.4.0.1149) (Kratos Analytical, Japan) was utilized to obtain spectra and quantify chemical bond [20].

### Formulation Stability Analysis

The stability of the formulations was analyzed by taking 25 mL of coating formulations of PU and PU composites in cylindrical glass vials. The vials were then scanned by a suspension stability analyzer called a Turbiscan lab expert (Formulation, France) every 30 seconds for a period of 12 h at 30° C. [21].

### Mechanical and Thermal Property Analysis of Films

The mechanical properties of PU and PU composite films were examined using universal testing equipment with a 200 N load cell (Shimadzu Instrone-6800 series, Japan). Samples were cut from composite sheets with a dog bone-shaped die, measuring 27×3.12×0.1 cm (ASTM D638 type V). Three specimens from each film were evaluated at 50 mm/min and room temperature, and average values with error bars were reported [22].

The thermal stability and degradation temperature of KL, WL, SL, PU composite films were investigated by thermogravimetric analysis (TGA) instrument (TGAi1000, Instrument Specialists Inc., WI, USA). The instrument was loaded with 10-10.36 mg of dried samples in a Tzero® aluminum pan. The analysis was conducted in a nitrogen environment with a flow rate of 10 mL/min and a heating rate of 10° C./min from 25° C. to 800° C. [23].

### Liquid Contact Angle, Water Absorption and UV Transmittance Analysis

The static liquid (water, 0.1M NaOH and 0.1M HCL) contact angle investigation of the samples utilized an optical tensiometer (Theta Lite, Bolin Scientific, Finland) with a digital camera and manual tilting stage. The sessile liquid droplet approach from one attention program was utilized for the static contact angle analysis. The test involved placing a 6-10 μL liquid droplet on the PU films, coated wood, metal and paper surface and measuring the contact angle of the droplet on the surfaces visually using a camera for 50 seconds.

A tilting stage test was processed for the water sliding angle analysis of the generated films. The test involved placing a water droplet (6-10 μL) on the surfaces at 180° on the tilting stage and slowly tilting it until the droplet started to slide. The measurement was repeated three times and reported as a mean with the standard deviation.

The films' water absorption characteristics were assessed by a force tensiometer (attention sigma 700/701, Biolin Scientific, Finland) with a metal probe. The study was conducted by immersing a cylindrical metal tube with an open bottom base containing 0.01 mg of the films into a liquid. The amount of liquid absorbed by the films was determined using the Washburn technique Equation (1).

$$W 2 = Cp γ l cos θ t / 2 η \qquad ( 1 )$$

Where W is the weight of absorbed water (g), C is a geometric constant (0.04), p is the liquid density (0.998 g/mL), y is surface tension (72.8 mN/m), L is the length of the powder glass probe (5.5 mm), n is the viscosity of the liquid (0.01 g/cm.s), and t is measurements time (300 s). The UV transmittance of the films was evaluated using a UV-Vis spectrophotometer (UV-2600i, SHIMADZU, Japan) in the range of 200-800 nm.

### Durability Analysis for Abrasion, Thermal and UV-Ozone

A wood, paper, and metal sample, coated with PWL50S, was brought in contact with 1500 mesh sandpaper. A 20 g weight was then placed on top of the samples and pushed down a straight line. Water contact angle analysis was conducted after each 30 cm length of abrasion.

Wood surfaces are prone to thermal and UV exposure degradation, leading to higher moisture deterioration; therefore, the coated wood hydrophobicity was assessed after exposure to thermal and UV ozone. To analyze the stability in the hydrophobicity of coated wood after thermal exposure, the coated wood samples were subjected to a temperature of 200° C. in an oven. The water contact angle of the samples was then measured at different time intervals. Similarly, the wood samples coated with a protective layer were subjected to UV-ozone exposure for varying durations. Subsequently, the water contact angle of the samples was evaluated.

### Ignition Performance of Films and Coated Samples

An ASTM D 2843-99 method was utilized to determine the smoke emission parameters of coated wood by investigating the smoke generation profile with a smoke density test apparatus (AIC-2843, Advanced Instrument Co., Ltd., China). The coated samples (42 mm×42 mm×4 mm) were placed in the instrument and subjected to 0.14 MPa propane gas pressure for 250 seconds after ignition. The light absorption curves and smoke density ratings (SDRs) of the samples were analyzed and reported [24]. The limiting oxygen index (LOI) analyzer (NETZSCH TAURUS apparatus, Germany) determined the lowest oxygen needed to ignite film samples according to ASTM D2863. The films and coated wood samples were tested using this method in a controlled mixture of nitrogen and oxygen environment. Sample dimensions were 140 mm×20 mm×10 mm for wood and 120 mm×35 mm×2.5 mm for films, and the test was conducted in five replicates [25]. The flame test was performed to simulate real-life fire scenarios, films, coated wood and papers were subjected to an intense propane gas flame to initiate ignite. Images were captured to depict the reaction of the samples visually.

While the preferred embodiments of the invention have been described above, it will be recognized and understood that various modifications may be made therein, and the appended claims are intended to cover all such modifications which may fall within the spirit and scope of the invention.

TABLE 1
PU films' elongation, tensile strength, and modulus as prepared and recycled.

| | | | Tensile strength, | | | | | |
|---|---|---|---|---|---|---|---|---|
| | Elongation, % | | MPa | | Modulus, MPa | | Contact angle, ° | |
| Sample | Virgin | Recycled | Virgin | Recycled | Virgin | Recycled | Virgin | Recycled |
| PS | 50 ± 3.6 | 59.1 ± 0.6 | 4.5 ± 0.1 | 9.64 ± 0.4 | 209 ± 149 | 796.9 ± 151 | 90 ± 2 | 90 ± 0.5 |
| PKL10S | 85 ± 3.9 | 56.1 ± 10 | 14.9 ± 3 | 47.35 ± 5 | 584.5 ± 123 | 2006.3 ± 22 | 30 ± 2 | 29 ± 5 |
| PWL10S | 74.3 ± 8.4 | 9.3 ± 0.5 | 3.9 ± 0.7 | 39.8 ± 2 | 350 ± 166 | 592.6 ± 157 | 140 ± 3 | 142 ± 3 |
| PWL50S | 20.4 ± 9.5 | 10.7 ± 4.5 | 2.4 ± 0.2 | 10.2 ± 0.1 | 92.7 ± 41 | 447.1 ± 2.6 | 158 ± 2 | 160 ± 3 |

The term “virgin” refers to the specimens in their unaltered state.

TABLE 2
Comparing lignin concentration, tensile strength, water contact angle,
and limiting oxygen index value from this work and existing work.

| | | | Tensile | | | |
|---|---|---|---|---|---|---|
| | Method of lignin | Maximum lignin | strength, | | LOI, | |
| Composition | modification | concentration, % | MPa | WCA, ° | % | Reference |
| Industrial alkali | Quaternization | 1.2 | 25 | x | x | 20 |
| lignin, ZnO, PU | (QAL) | | | | | |
| Kraft lignin, and | QAL/ZnO composite | 2 | 7 | x | x | 21 |
| PU | Silanization with 3- | | | | | |
| | aminopropyltriethoxy | | | | | |
| | silane 99% | | | | | |
| Lignin, PU, | Unmodified | 3 | 57 | 110.3 | x | 67 |
| dimethylacetamide | | | | | | |
| kraft lignin, TiO₂, | Sulfonation | 2.8 | 9.9 | 85.9 | x | 68 |
| water-based PU | | | | | | |
| Lignin, Isocyanate | Lignin urethane | 30 | 13.3 | x | x | 69 |
| | modification | | | | | |
| Lignin, amine- | Lignin liquefaction | 3 | 9.2 | 73.2 | x | 62 |
| modified silica, | | | | | | |
| and isocyanate | | | | | | |
| Alkali lignin, | Demethylation | 70 | 58.8 | — | — | 63 |
| hexamethylene | | | | | | |
| diisocyanate | | | | | | |
| Lignin, PU | Lignin nanoparticles | 5 | 58 | 114 | x | 14a |
| Kraft lignin, PU | Lignin | 50.12 | 2.6 | 155 | 26 | This work |
| | copolymerized with | | | | | |
| | Silsesquioxane, | | | | | |
| | Sulfoethylation | | | | | |

Note,
“x” means not reported, PU (polyurethane), TiO₂ (titanium dioxide).

### REFERENCES

ADDIN EN.REFLIST 1. Akindoyo, J. O.; Beg, M.; Ghazali, S.; Islam, M.; Jeyaratnam, N.; Yuvaraj, A., Polyurethane types, synthesis and applications-a review. Rsc Advances 2016, 6 (115), 114453-114482.
2. Meier-Westhues, U.; Squiller, E., Polyurethanes: Coatings, Adhesives and Scalants; Vincentz Network GmbH & Co. KG: Hannover, Germany 2019.
3. Golling, F. E.; Pires, R.; Hecking, A.; Weikard, J.; Richter, F.; Danielmeier, K.; Dijkstra, D., Polyurethanes for coatings and adhesives-chemistry and applications. Polymer International 2019, 68 (5), 848-855.
4. Qiu, N.; Wang, L.; Wu, S.; Likhachev, D. S., Research on cavitation erosion and wear resistance performance of coatings. Engineering Failure Analysis 2015, 55, 208-223.
5. Yang, D.; Wang, S.; Zhong, R.; Liu, W.; Qiu, X., Preparation of lignin/TiO 2 nanocomposites and their application in aqueous polyurethane coatings. Frontiers of Chemical Science and Engineering 2019, 13, 59-69.
6. (a) Amado, J. C. Q., Thermal resistance properties of polyurethanes and its composites. In Thermosoftening Plastics, IntechOpen London, UK: 2019; Vol. 2019; (b) Lyman, D. J., Polyurethanes. I. The solution polymerization of diisocyanates with ethylene glycol. Journal of Polymer Science 1960, 45 (145), 49-59.
7. Engels, H. W.; Pirkl, H. G.; Albers, R.; Albach, R. W.; Krause, J.; Hoffmann, A.; Casselmann, H.; Dormish, J., Polyurethanes: Versatile materials and sustainable problem solvers for today's challenges. Angewandte Chemie International Edition 2013, 52 (36), 9422-9441.
8. Adetunji, C. O.; Olaniyan, O. T.; Anani, O. A.; Inobeme, A.; Mathew, J. T., Environmental impact of polyurethane chemistry. Polyurethane Chemistry: Renewable Polyols and Isocyanates 2021, 393-411.
9. Bean, R. H.; Long, T. E., Recent trends in the additive manufacturing of polyurethanes.

### Polymer International 2024, 73 (1), 5-8.

10. Zhao, H.; Gao, W.-C.; Li, Q.; Khan, M. R.; Hu, G.-H.; Liu, Y.; Wu, W.; Huang, C.-X.; Li, R. K. Y., Recent advances in superhydrophobic polyurethane: Preparations and applications. Advances in Colloid and Interface Science 2022, 303, 102644.
11. Ma, X.; Chen, J.; Zhu, J.; Yan, N., Lignin-based polyurethane: recent advances and future perspectives. Macromolecular Rapid Communications 2021, 42 (3), 2000492.
12. (a) Zhang, D.; Zeng, J.; Liu, W.; Qiu, X.; Qian, Y.; Zhang, H.; Yang, Y.; Liu, M.; Yang, D., Pristine lignin as a flame retardant in flexible PU foam. Green Chemistry 2021, 23 (16), 5972-5980; (b) Ridho, M. R.; Agustiany, E. A.; Rahmi Dn, M.; Madyaratri, E. W.; Ghozali, M.; Restu, W. K.; Falah, F.; Rahandi Lubis, M. A.; Syamani, F. A.; Nurhamiyah, Y., Lignin as green filler in polymer composites: Development methods, characteristics, and potential applications. Advances in Materials Science and Engineering 2022, 2022, 1-33; (c) Chen, Y.; Fu, S.; Zhang, H., Signally improvement of polyurethane adhesive with hydroxy-enriched lignin from bagasse. Colloids and Surfaces A: Physicochemical and Engineering Aspects 2020, 585, 124164.
13. Li, H.; Liang, Y.; Li, P.; He, C., Conversion of biomass lignin to high-value polyurethane: A review. Journal of Bioresources and Bioproducts 2020, 5 (3), 163-179.
14. (a) Wu, L.; Liu, S.; Wang, Q.; Wang, Y.; Ji, X.; Yang, G.; Chen, J.; Li, C.; Fatchi, P., High strength and multifunctional polyurethane film incorporated with lignin nanoparticles. Industrial Crops and Products 2022, 177, 114526; (b) Qi, G.; Yang, W.; Puglia, D.; Wang, H.; Xu, P.; Dong, W.; Zheng, T.; Ma, P., Hydrophobic, UV resistant and dielectric polyurethane-nanolignin composites with good reprocessability. Materials & Design 2020, 196, 109150.
15. (a) Wang, X.; Nayanathara, R. O.; Leng, W.; Caldona, E. B.; Liu, L.; Advincula, R. C.; Zhang, Z.; Zhang, X., Corrosion-resistant polyurethane coatings from structure-homogenized biorefinery lignin through fractionation and oxypropylation. Journal of Agriculture and Food Research 2022, 10, 100452; (b) Wang, H.; Qiu, X.; Liu, W.; Fu, F.; Yang, D., A novel lignin/ZnO hybrid nanocomposite with excellent UV-absorption ability and its application in transparent polyurethane coating. Industrial & Engineering Chemistry Research 2017, 56 (39), 11133-11141; (c) Ng, Q. Y.; Low, J. H.; Pang, M. M.; Idumah, C. I., Properties enhancement of waterborne polyurethane bio-composite films with 3-aminopropyltricthoxy silane functionalized lignin. Journal of Polymers and the Environment 2023, 31 (2), 688-697.
16. Shi, M.; Wang, X.; Yang, J., Development of lignin-based waterborne polyurethane materials for flame retardant leather application. Polymer Bulletin 2023, 80 (5), 5553-5571.
17. Bemerw Kassaun, B.; Fatchi, P., Solvent-Free Lignin-Silsesquioxane wood coating formulation with superhydrophobic and Flame-Retardant functionalities. Chemical Engineering Journal 2024, 493, 152582.
18. Bahrpaima, K.; Fatchi, P., Synthesis and characterization of carboxyethylated lignosulfonate. ChemSusChem 2018, 11 (17), 2967-2980.
19. Meng, X.; Crostini, C.; Ben, H.; Hao, N.; Pu, Y.; Ragauskas, A. J.; Argyropoulos, D. S., Determination of hydroxyl groups in biorefinery resources via quantitative 31P NMR spectroscopy. Nature Protocols 2019, 14 (9), 2627-2647.
20. (a) Johansson, L.-S.; Campbell, J.; Koljonen, K.; Stenius, P., Evaluation of surface lignin on cellulose fibers with XPS. Applied surface science 1999, 144, 92-95; (b) Stark, N. M.; Yelle, D. J.; Agarwal, U. P., Techniques for characterizing lignin. Lignin in polymer composites 2016, 49-66.
21. Zhang, J.; Cui, H.; Qiu, J.; Wang, X.; Zhong, Y.; Yao, C.; Yao, L.; Zheng, Q.; Xiong, C., Stability of glycosylated complexes loaded with Epigallocatechin 3-gallate (EGCG). Food Chemistry 2023, 410, 135364.
22. Rostami, M.; Mohseni, M.; Ranjbar, Z., An attempt to quantitatively predict the interfacial adhesion of differently surface treated nanosilicas in a polyurethane coating matrix using tensile strength and DMTA analysis. International journal of adhesion and adhesives 2012, 34, 24-31.
23. (a) Deng, Y.; Huang, S.; Liu, Y.; Xu, J.; Li, Z.; He, S.; Zhang, J., Preparation and relationship between structure and properties of PTMEG based polyurethane acrylate UV cured films. Journal of Macromolecular Science, Part A 2023, 60 (1), 63-70; (b) Riddell, L. A.; Enthoven, F. J.; Lindner, J.-P. B.; Meirer, F.; Bruijnincx, P. C., Expanding lignin thermal property space by fractionation and covalent modification. Green Chemistry 2023, 25 (15), 6051-6056.
24. Mamatha, B.; Sujatha, D.; Nath, S.; Uday, D.; Nandanwar, A. In Development of Fire Retardant Wood Composite Using Amino Resin, Wood is Good: Current Trends and Future Prospects in Wood Utilization, Springer: 2017; pp 353-361.
25. Sykam, K.; Hussain, S. S.; Sivanandan, S.; Narayan, R.; Basak, P., Non-halogenated UV-curable flame retardants for wood coating applications. Progress in Organic Coatings 2023, 179, 107549.
26. Ghavidel, N.; Fatehi, P., Pickering/Non-Pickering Emulsions of Nanostructured Sulfonated Lignin Derivatives. ChemSusChem 2020, 13 (17), 4567-4578.
27. (a) Nagy, M.; Kosa, M.; Theliander, H.; Ragauskas, A. J., Characterization of CO 2 precipitated Kraft lignin to promote its utilization. Green Chemistry 2010, 12 (1), 31-34; (b) Mahmood, N.; Yuan, Z.; Schmidt, J.; Xu, C. C., Production of polyols via direct hydrolysis of kraft lignin: Effect of process parameters. Bioresource technology 2013, 139, 13-20.
28. Ibarra, D.; Garcíα-Fuentevilla, L.; Domínguez, G.; Martín-Sampedro, R.; Hernández, M.; Arias, M. E.; Santos, J. I.; Eugenio, M. E., NMR Study on Laccase Polymerization of Kraft Lignin Using Different Enzymes Source. International Journal of Molecular Sciences 2023, 24 (3), 2359.
29. Richle, N.; Thude, S.; Kandelbauer, A.; Tovar, G. E.; Lorenz, G., Synthesis of soft polysiloxane-urea elastomers for intraocular lens application. JoVE (Journal of Visualized Experiments) 2019, (145), c58590.
30. Zhao, C.; Huang, J.; Yang, L.; Yuc, F.; Lu, F., Revealing Structural Differences between Alkaline and Kraft Lignins by HSQC NMR. Industrial & Engineering Chemistry Research 2019, 58 (14), 5707-5714.
31. An, L.; Wang, G.; Jia, H.; Liu, C.; Sui, W.; Si, C., Fractionation of enzymatic hydrolysis lignin by sequential extraction for enhancing antioxidant performance. International journal of biological macromolecules 2017, 99, 674-681.
32. Ghavidel, N.; Konduri, M. K.; Fatchi, P., Chemical reactivity and sulfo-functionalization response of enzymatically produced lignin. Industrial Crops and Products 2021, 172, 113950.
33. Schmidt, H.; Scholze, H.; Kaiser, A., Principles of hydrolysis and condensation reaction of alkoxysilanes. Journal of Non-Crystalline Solids 1984, 63 (1-2), 1-11.
34. Chen, X.; Wang, X.; Fang, D., A review on Cls XPS-spectra for some kinds of carbon materials. Fullerenes 2020, 28 (12), 1048-1058.
35. (a) Liu, S.; Cao, W.; Wang, Y.; Wei, W.; Li, L.; Jin, H.; Guo, L., Characteristics and mechanisms of nitrogen transformation during chicken manure gasification in supercritical water. Waste Management 2022, 153, 240-248; (b) Miletić, A.; Panjan, P.; Čekada, M.; Kovačević, L.; Terek, P.; Kovač, J.; Dražič, G.; Škorić, B., Nanolayer CrAIN/TiSiN coating designed for tribological applications. Ceramics International 2021, 47 (2), 2022-2033.
36. Arefmanesh, M.; Vuong, T. V.; Mobley, J. K.; Alinejad, M.; Master, E. R.; Nejad, M., Bromide-based ionic liquid treatment of hardwood organosolv lignin yielded a more reactive biobased polyol. Industrial & Engineering Chemistry Research 2020, 59 (42), 18740-18747.
37. Kaur, A.; Chahal, P.; Hogan, T., Selective fabrication of SiC/Si diodes by excimer laser under ambient conditions. IEEE Electron Device Letters 2015, 37 (2), 142-145.
38. Pomeroy, M., Coatings for gas turbine materials and long term stability issues. Materials & design 2005, 26 (3), 223-231.
39. Miele, N. A.; Volpe, S.; Torricri, E.; Cavella, S., Improving physical properties of sodium caseinate based coating with the optimal formulation: Effect on strawberries' respiration and transpiration rates. Journal of Food Engineering 2022, 337, 111123.
40. Mishra, A. K.; Chattopadhyay, D.; Srecdhar, B.; Raju, K., FT-IR and XPS studies of polyurethane-urea-imide coatings. Progress in organic coatings 2006, 55 (3), 231-243.
41. Jiang, C.; Hc, H.; Yao, X.; Yu, P.; Zhou, L.; Jia, D., The aggregation structure regulation of lignin by chemical modification and its effect on the property of lignin/styrene-butadiene rubber composites. Journal of Applied Polymer Science 2018, 135 (5), 45759.
42. Wu, Z.; Wang, H.; Tian, X.; Xuc, M.; Ding, X.; Ye, X.; Cui, Z., Surface and mechanical properties of hydrophobic silica contained hybrid films of waterborne polyurethane and fluorinated polymethacrylate. Polymer 2014, 55 (1), 187-194.
43. Kashfipour, M. A.; Mehra, N.; Zhu, J., A review on the role of interface in mechanical, thermal, and electrical properties of polymer composites. Advanced Composites and Hybrid Materials 2018, 1, 415-439.
44. Jamali, M.; Moghadam, A.; Tafreshi, H. V.; Pourdeyhimi, B., Droplet adhesion to hydrophobic fibrous surfaces. Applied Surface Science 2018, 456, 626-636.
45. Samuel, B.; Zhao, H.; Law, K.-Y., Study of wetting and adhesion interactions between water and various polymer and superhydrophobic surfaces. The Journal of Physical Chemistry C 2011, 115 (30), 14852-14861.
46. Bansal, A.; Yang, H.; Li, C.; Cho, K.; Benicewicz, B. C.; Kumar, S. K.; Schadler, L. S., Quantitative equivalence between polymer nanocomposites and thin polymer films. Nature materials 2005, 4 (9), 693-698.
47. Dias, G.; Prado, M. A.; Caronc, C.; Ligabue, R.; Dumas, A.; Martin, F.; Le Roux, C.; Micoud, P.; Einloft, S., Synthetic silico-metallic mineral particles (SSMMP) as nanofillers: comparing the effect of different hydrothermal treatments on the PU/SSMMP nanocomposites properties. Polymer Bulletin 2015, 72, 2991-3006.
48. Xiao, X.; Jiang, J.; Wang, Y.; Wang, B.; Yuan, T.-Q.; Shi, Q.; Liao, X.; Shi, B.; Sun, R.-C., Microwave-assisted sulfonation of lignin for the fabrication of a high-performance dye dispersant. ACS Sustainable Chemistry & Engineering 2021, 9 (27), 9053-9061.
49. Li, X.; Liu, Y.; Ren, X., Transparent and ultra-tough PVA/alkaline lignin films with UV shielding and antibacterial functions. International Journal of Biological Macromolecules 2022, 216, 86-94.
50. Kim, B. M.; Choi, J. S.; Jang, S.; Park, H.; Lec, S. Y.; Jung, J.; Park, J., Sustainable Strategies for Synthesizing Lignin-Incorporated Bio-Based Waterborne Polyurethane with Tunable Characteristics. Polymers 2023, 15 (19), 3987.
51. Huang, J.; Wang, H.; Liu, W.; Huang, J.; Yang, D.; Qiu, X.; Zhao, L.; Hu, F.; Feng, Y., Solvent-free synthesis of high-performance polyurethane elastomer based on low-molecular-weight alkali lignin. International Journal of Biological Macromolecules 2023, 225, 1505-1516.
52. Agustiany, E. A.; Rasyidur Ridho, M.; Rahmi DN, M.; Madyaratri, E. W.; Falah, F.; Lubis, M. A. R.; Solihat, N. N.; Syamani, F. A.; Karungamye, P.; Sohail, A., Recent developments in lignin modification and its application in lignin-based green composites: A review. Polymer Composites 2022, 43 (8), 4848-4865.
53. (a) Evstigneev, E. I., Factors affecting lignin solubility. Russian Journal of Applied Chemistry 2011, 84 (6), 1040-1045; (b) Glasser, W. G., About making lignin great again-some lessons from the past. Frontiers in chemistry 2019, 7, 565.
54. Liu, Y.; Shao, Y.; Wang, Y.; Wang, J., An abrasion-resistant, photothermal, superhydrophobic anti-icing coating prepared by polysiloxane-modified carbon nanotubes and fluorine-silicone resin. Colloids and Surfaces A: Physicochemical and Engineering Aspects 2022, 648, 129335.
55. Rabbani, S.; Bakhshandch, E.; Jafari, R.; Momen, G., Superhydrophobic and icephobic polyurethane coatings: Fundamentals, progress, challenges and opportunities. Progress in Organic Coatings 2022, 165, 106715.
56. Pearce, E., Flame-retardant polymeric materials. Springer Science & Business Media: 2012.
57. Imhof, L.; Stueben, K., Evaluation of the smoke and flammability characteristics of polymer systems. Polymer Engineering & Science 1973, 13 (2), 146-152.
58. Zhao, L.; Semetey, V., Recycling polyurethanes through transcarbamoylation. ACS omega 2021, 6 (6), 4175-4183.
59. Bakkali-Hassani, C.; Berne, D.; Ladmiral, V.; Caillol, S., Transcarbamoylation in Polyurethanes: Underestimated Exchange Reactions? Macromolecules 2022, 55 (18), 7974-7991.
60. Macocinschi, D.; Filip, D.; Vlad, S., Surface and mechanical properties of some new biopolyurethane composites. Polymer Composites 2010, 31 (11), 1956-1964.
61. (a) Wu, J.; Wu, X.; Mu, C.; Wang, C.; Lin, W., Pickering emulsion approach: A novel strategy to fabricate waterborne polyurethane with enhanced abradability and water-resistance comparable to that of solvent-based coating. Progress in Organic Coatings 2024, 188, 108174; (b) Dai, S.; Yan, F.; Ma, J.; Guo, J.; Hu, H.; Liu, Y.; Liu, L.; Ao, Y., Hybridization of cellulose nanocrystals modified ZnO nanoparticles with bio-based hyperbranched waterborne polyurethane sizing agent for superior UV resistance and interfacial properties of CF/PA6 composites. Composites Science and Technology 2024, 245, 110328; (c) Zheng, H.; Pan, M.; Wen, J.; Yuan, J.; Zhu, L.; Yu, H., Robust, Transparent, and Superhydrophobic Coating Fabricated with Waterborne Polyurethane and Inorganic Nanoparticle Composites. Industrial & Engineering Chemistry Research 2019, 58 (19), 8050-8060.
62. Xue, B.; Yang, Y.; Tang, R.; Sun, Y.; Sun, S.; Cao, X.; Li, X., Polyurethane composite films based on modified lignin and reinforced with silica nanoparticles: synthesis and characterization. BioResources 2019, 14 (3), 6100-6113.
63. Wang, D.; Shan, Y.; Liu, L.; Diao, M.; Yao, J., Lignin demethylation enabled robust and reprocessable bio-polyurethane elastomer with adaptable cross-linking network. Industrial Crops and Products 2024, 208, 117905.

1. A method of synthesizing a polyurethane copolymer comprising:
a) mixing a first lignin and a suitable silsquioxane molecule, thereby forming a copolymerized lignin;
b) mixing a second lignin and a base, thereby forming a mixture;
adding a sulfoethylation reagent to the mixture and refluxing the mixture, thereby forming a sulfoethylated lignin; and
recovering the sufloethylated lignin
c) mixing the copolymerized lignin, the sufloethylated lignin and a polyurethane, thereby forming the polyurethane copolymer.

2. The method according to claim 1 wherein the silsquioxane molecule is aminopropyl/methyl silsesquioxane, aminopropyl/flurosilsesquioxane, aminoethylaminopropylsilsquioxane or minopropyl, vinylsilsquioxane.

3. The method according to claim 1 wherein the first lignin and the second lignin are independently selected from kraft lignin, alkali lignin, soda lignin, hydrolysis lignin and lignosulfonate.

4. The method according to claim 1 wherein the sulfoethylated lignin is added to the copolymerized lignin and the polyurethane at about 0.05 wt. % to about 0.2 wt. %.

5. The method according to claim 1 wherein the sulfoethylated lignin is added to the copolymerized lignin and the polyurethane at about 0.12 wt. %, of the polyurethane copolymer.

6. The method according to claim 1 wherein the copolymerized lignin is added to the polyurethane at about 5 wt. % to about 80 wt. % of the polyurethane copolymer.

7. The method according to claim 1 wherein the copolymerized lignin is added to the polyurethane at about 20 wt. % to about 60 wt. % of the polyurethane copolymer.

8. The method according to claim 1 wherein the first lignin is mixed with the suitable silsquioxane molecule in an aqueous environment.

9. The method according to claim 1 wherein the first lignin is about 5 wt. % to about 80 wt. % of the copolymerized lignin.

10. The method according to claim 1 wherein the first lignin is about 20 wt. % to about 60 wt. % of the copolymerized lignin.

11. The method according to claim 1 wherein the first lignin and the suitable silsquioxane molecule are mixed at a temperature of at least about 60° C.

12. The method according to claim 11 wherein the first lignin and the suitable silsquioxane molecule are reacted for at least about 48 hours.

13. The method according to claim 1 wherein a C1-C4 alcohol is added with the base.

14. The method according to claim 1 wherein the C1-C4 alcohol is isopropyl alcohol.

15. The method according to claim 1 wherein the base is NaOH.

16. The method according to claim 1 wherein the sulfoethylation reagent is sodium 2-bromoethanesulfonate.

17. The method according to claim 16 wherein the mixture is refluxed at about 80° C.

18. The method according to claim 16 wherein the mixture is refluxed for about 2 hours.

19. The method according to claim 16 wherein the sulfoethylation reagent is added at about 60% mmol of the second lignin.

20. The method according to claim 1 wherein the polyurethane is in the form of an emulsion.

21. A film prepared from a polyurethane copolymer prepared according claim 1.

22. A method of improving hydrophobicity of an article comprising coating the article with a polyurethane copolymer prepared according to the method of claim 1, said article having higher hydrophobicity than an identical article except for the polyurethane copolymer coating.

23. The method according to claim 22 wherein the article is composed of plastic, wood, paper, metal or glass.

24. A method of improving fire retardant properties of an article comprising coating the article with a polyurethane copolymer prepared according to the method of claim 1, said article having higher fire retardant properties than an identical article except for the polyurethane copolymer coating.

25. The method according to claim 24 wherein the article is composed of plastic, wood, paper, metal or glass.
